(19) United States
(12) Patent Application Publication
(10) Pub. No.: US 2025/0179326 A1
(43) Pub. Date: Jun. 5, 2025

(54) USE OF ORGANIC CONDUCTIVE POLYMER FOR MULTIPLEX ION BEAM IMAGING

(71) Applicant: The Board of Trustees of the Leland Stanford Junior University, Stanford, CA (US)

(72) Inventors: Marc BOSSE, Redwood City, CA (US); Sean C. BENDALL, Palo Alto, CA (US); Robert M. ANGELO, Menlo Park, CA (US)

(21) Appl. No.: 18/698,775

(22) PCT Filed: Oct. 7, 2022
(86) PCT No.: PCT/US2022/046125

§ 371 Date: Apr. 4, 2024

Related U.S. Application Data
(60) Provisional application No. 63/254,360, filed on Oct. 11, 2021.

(51) Int. Cl. C09D 165/00; C08G 61/12; C08G 73/02; C09D 179/02; G01N 1/30; H01B 1/12

(52) U.S. Cl. CPC C09D 165/00; C08G 61/126; C08G 73/0266; C09D 179/02; G01N 1/30; H01B 1/127; H01B 1/128; C08G 2261/3223; C08G 2261/792

(57) ABSTRACT

Provided herein is a combination comprising: an optically transparent substrate, a sample that comprises biological analytes, and a layer of a conductive organic polymer. In this combination, the layer of polymer may be between the sample and the substrate, the layer of polymer may coat the section on the opposite side to the substrate, or both. The method comprises a liquid composition, wherein the composition comprises PEDOT, PSS, DMS02 and an organic solvent or polyaniline (emeraldine salt), DMS02 and an organic solvent; and wherein the applying comprises spraying, spin coating or spreading a composition comprising a solvent and the polymer on the surface of the substrate and then removing the solvent by evaporation. Methods of analyzing the sample in this combination are also provided.

### CROSS-REFERENCING

This application claims the benefit of U.S. provisional application Ser. No. 63/254,360, filed on Oct. 11, 2021, which application is incorporated by reference in its entirety herein.

### GOVERNMENT RIGHTS

This invention was made with Government support under contract AG057915 awarded by the National Institutes of Health. The Government has certain rights in the invention.

### BACKGROUND

Multiplex Ion Beam Imaging (MIBI) methods involve scanning a mass-tagged sample with a primary ion beam and detecting the sputtered elements (which are often referred to as “secondary ions”) by mass spectrometry, e.g., using a time-of-flight spectrometer. Each pixel of the scan will have a mass spectrum and, as such, the mass spectrometry data can be used to generate a high parameter image of the sample.

In a conventional MIBI assay, a specimen (typically a tissue section or single cells) that is labeled with mass tags is analyzed on a planar substrate, typically a glass microscope slide, that is coated in a metal such as gold (Au) to prevent surface charge accumulation. Au has higher m/z than the mass tags and, as such, the peak for Au can be spectrally separated from the peaks for the mass tags. However, some samples (e.g., placenta and lung tissue) are relatively porous and, as such, the proportion of “exposed” Au can be at a level in which sputtered Au ions account for the majority of the total ion counts and contribute to the background across all m/zs. Other samples (e.g., brain tissue such as cerebellum tissue) are relatively dense or the density may vary across the sample. In these cases, poor conductivity in the dense areas leads to charge accumulation which, in turn, decreases the amount of free secondary ions that can be detected and an inconsistent signal. In theory, this problem could be solved by sputter coating the sample with a metal (e.g., a 10 nm layer of gold, Au) prior to analysis. However, while this may solve the charge accumulation problem it would drastically increase the total ion counts and increase the background (as described above for the porous samples).

This disclosure provides a solution to this problem.

### SUMMARY

The problem described above has been solved by the addition of layer of a conductive organic polymer, such as a layer of a poly(3,4-ethylenedioxythiophene) polystyrene sulfonate (PEDOT:PSS) polymer to the slide. The layer can be applied over the sample, under the sample, or both above and below the sample. In certain embodiments, the layer of conductive polymer may be used instead of the metal layer. In other embodiments, the layer of conductive polymer may be used in addition to the metal layer. The conductive organic polymer reduces charge accumulation and improves signal uniformity across the region of interest, as well as reduces background. Moreover, the conductive organic polymer may be formulated to contain a cross-linking agent, which improves adhesion of soft tissues (e.g., samples of lung, breast or brain, etc.) to the substrate.

In some embodiments, a combination is provided. In these embodiments, the combination may comprise: (a) an optically transparent substrate, (b) sample that comprises biological analytes, and (c) a layer of a conductive organic polymer. In these embodiments, the layer of polymer may be between the sample and the substrate, the layer of polymer may coat the sample on the opposite side to the substrate, or both.

A method for preparing a substrate is also provided. In these embodiments, the method may comprise (a) functionalizing an optically transparent substrate and (b) applying a layer of a conductive organic polymer to the functionalized substrate. In these embodiments, the optically transparent substrate is silanized in step (a). In some cases, the layer of (b) may comprise a cross-linking agent (e.g., silane or a siloxane) that improves adhesion of a soft tissue sample to the layer.

In some embodiments the method may comprise placing a sample that comprises biological analytes on an optically transparent substrate and applying a layer of a conductive organic polymer on top of the sample.

A further combination is also provided. In these embodiments, the combination may comprise (a) an optically transparent substrate and (b) a layer of a conductive organic polymer that is on a surface of the substrate. In these embodiments, the layer of (b) may comprise a cross-linking agent (e.g., a silane or a siloxane) that improves adhesion of a soft tissue sample.

### BRIEF DESCRIPTION OF THE FIGURES

Certain aspects of the following detailed description are best understood when read in conjunction with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 illustrates the use of an organic conductive polymer (e.g., PEDOT:PSS) to prepare samples for Multiplex Ion Beam Imaging (MIBI). (a) Shows a drawing (transversal view) of a conventional set-up for MIBI. In this arrangement, the tissue to be analyzed is deposited on a glass support precoated with gold, stained and then dried under vacuum. In the arrangement shown in (b), a dried, stained sample on a standard gold coated support is coated with an organic conductive polymer formulation (in this case PEDOT:PSS, DMSO₂, and methanol) and then dried under vacuum before image acquisition. In the arrangement shown in (c) a glass support is coated with an organic conductive polymer formulation (e.g., PEDOT:PSS, DMSO₂). In this arrangement, the tissue is then deposited on the polymer, stained and dried under vacuum before image acquisition. In the arrangement shown in (d) a glass support is coated in an organic conductive polymer, the sample is placed on the support, stained and dried, and then the sample is coated with the organic conductive polymer (using a PEDOT:PSS, DMSO₂, methanol solution).

FIG. 2 is a drawing (transversal view) of a glass support coated with polyethylenimine to improve surface wettability. An organic conductive polymer formulation (e.g., PEDOT:PSS, methanol) is then coated either using a spraying or a meniscus spreading method (e.g., slot-die coater). In this arrangement, the tissue is then deposited on the polymer, stained and dried under vacuum before image acquisition.

FIGS. 3A-3C: MIBI images on multiple tissue sections comparing standard gold slide with an organic conductive polymer (PEDOT:PSS) coated slides. FIG. 3A: Photo of standard gold slide (left side) and a PEDOT:PSS coated slide (right side) on MIBI stage. Tissue microarrays with dense and porous tissues were deposited on each slide and stained for MIBI. FIG. 3B Shows MIBI images of beta-tubulin stain and gold on In113 and Au197 respective channels. The beta-tubulin stain is defining structural features of the tissues. The two dense tissues show a uniform cell distribution across the FOVs. The two porous tissues show sparse group of cells and connective tissues with bare regions. Image of the Au197 mass shows high intensity in porous tissues where exposed gold from the slide is detected. On the contrary, very low Au197 signal was detected from dense tissue images. FIG. 3C: The stain of beta-tubulin on organic conductive polymer coated slide shows similar and well define structures in both type of tissues. Conversely, no signal was detected in Au197 channel. Organic conductive polymer coated slide (e.g., PEDOT:PSS, methanol) replaces the use standard gold slide or other metal/inorganic coated slide for MIBI.

FIG. 4 MIBI image of single cell pellet in agarose and embedded in paraffin. (a) Photo of PEDOT:PSS coated slide with cell pellet stained for MIBI (b) Secondary electron image of individual cells stained for MIBI. (c) MIBI image of dsDNA, a nuclear marker on Y89 channel. Nuclear stain can be observed distinctively on individual cells. Organic conductive slides can resolve single cells.

FIGS. 5A-5C: MIBI acquisition spectra on very porous tissue. FIG. 5A Secondary ion image of human lung tissue. It shows sparse tissue with predominant bare regions. FIG. 5B Spectra obtained from MIBI of a human lung tissue using a gold coated conductive slide. Tantalum, Ta181 and gold, Au197, the two metals used to fabricate the standard gold slide constitute the predominant ion counts acquired. FIG. 5AC Spectra obtained from MIBI of a human lung tissue using an organic conductive polymer. The spectra is devoid of ions counts for Ta181 and Au197. Total ion counts is therefore reduced significantly. The use of an organic conductive polymer eliminates tantalum, gold background noise.

FIGS. 6A-6C MIBI acquisition spectra on porous tissue. FIG. 6A Secondary ion image of human colon tissue. It shows sparse tissue with few bare regions. FIG. 6B Spectra obtained from MIBI of a human colon tissue using a gold coated conductive slide. Tantalum, Ta181 and gold, Au197, the two metals used to fabricate the standard gold slide constitute the predominant ion counts acquired with similar result shown in FIG. 5. FIG. 6C Spectra obtained from MIBI of a human colon tissue using an organic conductive polymer. The spectra is devoid of ions counts for Ta181 and Au197. Total ion counts is therefore reduced significantly. The use of an organic conductive polymer eliminates tantalum, gold background noise observed in porous tissues with few bare regions.

FIGS. 7A-7C MIBI acquisition spectra on dense tissue. FIG. 7A Secondary ion image of human tonsil tissue. It shows dense tissue with no bare region. FIG. 7B Spectra obtained from MIBI of a human tonsil tissue using a gold coated conductive slide. Overall ion counts observed are from the multiplex antibody stain. Tantalum, Ta181 and gold, Au197 signal are below 10000 counts. FIG. 7C Spectra obtained from MIBI of a human tonsil tissue using an organic conductive polymer. Overall ion counts observed with the organic conductive polymer slide is similar to the spectra observed

FIGS. 8A-8E Shows the use of organic conductive polymer to reduce noise background from an inorganic substrate. FIG. 8A Shows a drawing (transversal view) of a gold coated slide coated over with an organic conductive polymer formulation (in this case PEDOT:PSS and methanol). FIG. 8B Photo a standard gold slide with a section of the standard gold slide was coated with PEDOT:PSS and methanol. The gold tissue microarray with various type of tissues were stained for MIBI. FIGS. 8C and 8D Shows MIBI images of beta-tubulin stain and gold on In113 and Au197 respective channels with human placenta and human tonsil. FIG. 8C The image on a standard gold slide only, the beta-tubulin stain on placenta tissue shows regions with low intensity signal which corresponds to bare regions with high intensity signal on Au197. The image of PEDOT coated gold slide, the beta-tubulin stain on placenta tissue shows similar stain compared to a standard gold slide and Au197 signal intensity is significantly reduced. FIG. 8D Similar results are observed with human Tonsil, but the contribution of gold background is much lower. In this case, the PEDOT:PSS coating reduced extensively the Au197 signal. FIG. 8E Shows ions counts acquired on stained human placenta and tonsil with a standard gold slide or a PEDOT:PSS coated gold slide. The organic conductive polymer (e.g., PEDOT:PSS, methanol) reduces significantly the total ion counts in porous (placenta) or dense (tonsil) tissues. This reduction is mainly due to background noise from the sample support (e.g., gold slide) with less impact on target metal reporter (in this case beta-tubulin, In113). MIBI data file size is also reduced significantly.

FIGS. 9A-9D Shows the use of an organic conductive polymer (e.g., PEDOT:PSS) to improve Multiplex Ion Beam Imaging (MIBI) acquisition. FIG. 9A Shows a drawing (transversal view) of a dried, stained brain tissue (e.g., cerebellum) on a gold support coated with an organic conductive polymer formulation (in this case PEDOT:PSS, DMSO₂, and methanol) after tissue staining. FIG. 9B Picture of stained human cerebellum for MIBI. A PEDOT formulation was applied on the first half of the stained brain tissue before acquisition. The MIBI acquisition setting was successive 400 μM FOVs starting from one edge of the tissue, across the entire tissue, up the opposite side. The first 16 Field of Views (FOVs) covered the region coated with PEDOT:PSS, the FOVs 17 to 32 did not have PEDOT:PSS top coating. FIG. 9C Shows tiled MIBI images of two markers, Histone H3 a nucleus marker and CD56, a pan neuron marker. FIG. 9D Shows a violon plot of FOV mean pixel intensity for Histone H3 or CD56. Blue plots represent data from PEDOT:PSS coated tissue. Orange plots represent data from tissue not coated with PEDOT:PSS. In FIG. 9C, the signal intensity from FOVs close the center of the tissue without PEDOT:PSS are dimmer compared to FOVs coated with PEDOT:PSS. In FIG. 9D, the distribution of positive signal pixel intensity is more homogeneous with PEDOT:PSS compared uncoated tissue. Collectively, this data demonstrates that the signal intensity is significantly reduced due lack of conductivity and charging in the middle of large brain tissue, and this can be overcome by coating the tissue with an organic conductive polymer (e.g., PEDOT:PSS, methanol) after MIBI stain.

### DETAILED DESCRIPTION

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a,” “an,” and “the” include plural referents unless the context clearly dictates otherwise. Thus, for example, reference to “a layer” includes a plurality of such layers and reference to “the sample” includes reference to one or more samples and equivalents thereof known to those skilled in the art, and so forth. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

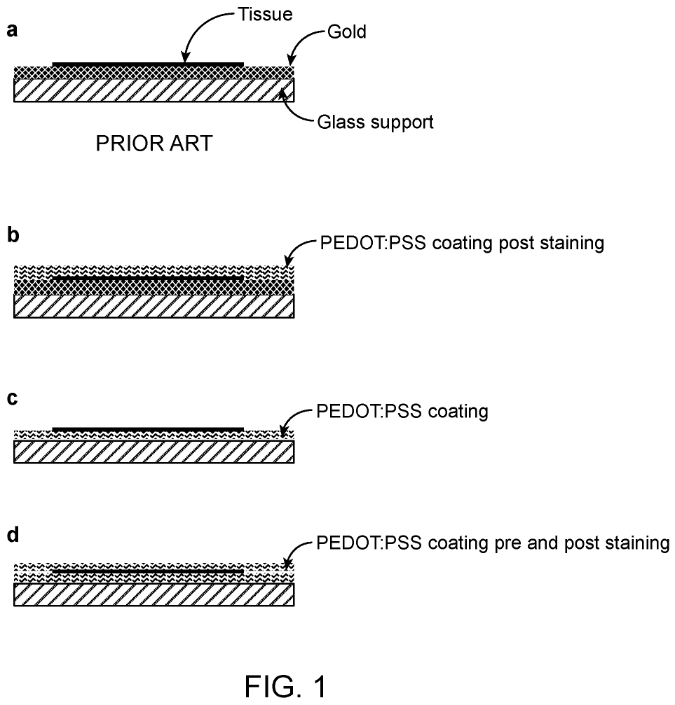

Certain principles of the present disclosure are illustrated in FIG. 1. As illustrated, in some embodiments the combination may comprise: an optically transparent substrate (referred to as a “glass support” in FIG. 1); a sample that comprises biological analytes (referred to as a “tissue” in FIG. 1) and a layer of a conductive organic polymer (referred to as “PEDOT:PSS” in FIG. 1). As illustrated, the layer of polymer can be on either or both sides of the sample, i.e., between the sample and the substrate (as shown in panel c), on the sample on the opposite side to the substrate (as shown in panel b), or on both sides of the sample (as illustrated in panel d). As shown, in panels b and d, if the layer of conductive polymer is over the sample, then there may be a layer of metal (gold) (panel b) or a layer of the polymer (panel d) between the sample and the substrate. In these embodiments, the term “optically transparent” is intended to refer to transparency to visible light, e.g., in the range of 400-700 nm.

The conductive organic polymer may be, for example, a polyfluorene, a polyphenylene, a polypyrene, a polyazulene, a polynaphthalene, a polyacetylene, a poly (p-phenylene vinylene), a polypyrrole, a polycarbazole, a polyindole, a polyazepine, a polyaniline, a polythiophene, a poly(3,4-ethylenedioxythiophene) (PEDOT) or a poly(p-phenylene sulfide). In some embodiments, the polymer is poly(3,4-ethylenedioxythiophene) (e.g., PEDOT:PSS) or a derivative thereof, e.g., a polymer made using (3,4-ethylenedioxythiophene; 2,3-Dihydrothieno[3,4][1,4]dioxin-2-yl) methanol; 2,5-dibromo-3,4-ethylenedioxythiophene; 2-chloromethyl-2,3-dihydrothieno[3,4-b]-1-4-dioxine). A variety of suitable PEDOT derivatives (e.g., poly(3,4-ethylenedioxythiophene)-R; R=polyethylene glycol etc.) are described in Mantione et al (Polymers 2017; 9:354). At least some of these polymers have been extensively used in electronics, solar cell, in vivo electrode and antistatic applications (see, e.g., Fan et al Adv Sci 2019 6:1900813, Hui et al Anal Chim Acta. 2018 1022:1-19 and Mantione et al Polymers (Basel). 2017 9:354) and can be readily adapted herein.

The layer of conductive organic polymer may have a thickness in the range of 1 nm to 500 nm (e.g., 5 nm to 500 nm, 10 nm to 500 nm, 50 to 150 nm, 100 to 300 nm, or 50 to 500 nm) although the layer of conductive organic polymer may have a thickness outside of this range in certain circumstances. Like the substrate, the conductive organic polymer may be optically transparent and, as such, PEDOT:PSS and polymers with similar properties can be used in many cases. For example, there are several alternatives listed above that could be used instead.

In some embodiments, the polymer may comprise a cross-linking agent that improves adhesion of a soft tissue sample. The cross-linking agent may be a silane or a siloxane, for example, such as 1,3-Bis(3-hydroxypropyl)tetramethyldisiloxane or a functionally similar molecule.

In any embodiment, the sample that comprises biological analytes may contain protein, lipid, nucleic acid, chromosomes, mitochondria, chloroplasts, nuclei, virus, single cells such as plasma/blood cells, unicellular organisms (e.g., yeast or bacteria), cells in culture or organoid tissue (as single cell or a whole tissue). In some embodiments, the sample may comprise cells, i.e., may be a sample of biological origin that contains intact, e.g., fixed, cells. In some embodiments, the sample may be substantially planar. Examples of such samples include tissue sections, samples that are made by depositing disassociated cells onto a planar surface, samples made by spreading cells on a surface, and samples that are made by growing a sheet of cells on a planar surface. Tissues can be deposited as a whole or sectioned or separated from an embedding matrix such as polyacrylamide gel, glycol methacrylate, paraffin, frozen section mounting media (ex. O.C.T.). In any embodiment, the sample may be adhered to the polymer layer via electrostatic interactions, e.g., via the crosslinking agent.

The optically transparent substrate may be glass or plastic and, in many cases may be the size of a typical microscope slide (i.e., about 25 mm×75 mm×1 mm, or 1 inch by 3 inches, by about 1 mm thick). As shown, the substrate will typically contain at least one planar surface upon which the sample is or will be mounted.

In some embodiments, the combination may be made by functionalizing a substrate and then adding the conductive organic polymer to the substrate. For example, in some embodiments, the conductive organic polymer can be suspended in an organic solvent then spread, sprayed or spun (as a liquid) onto the substrate. The solvent can then be removed in a vacuum, leaving the layer of polymer. In some embodiments, the optically transparent substrate may be silanized prior to addition of the polymer. The applying step comprises spraying, spin coating or spreading a composition comprising a solvent and the polymer onto the surface of the substrate and then removing the solvent by evaporation, for example. In some embodiments, the liquid applied to the substrate may contain a cross-linking agent (e.g., a silane or a siloxane such as 1,3-Bis(3-hydroxypropyl)tetramethyldisiloxane or a functionally similar molecule) that improves adhesion of a soft tissue sample to the layer. In some embodiments, the liquid applied to the substrate may comprise PEDOT, PSS, DMSO₂ and an organic solvent. In these embodiments, the DMSO₂ increases stability of PEDOT:PSS colloid in solution, improves film formation and conductivity. The DMSO₂ acts as a dopant to improve the formation of a uniform film.

In certain embodiments, the method may further comprise placing a sample that comprises biological analytes e.g., a tissue section, as described above, on the layer of polymer on the opposite side to the substrate. The sample may be labeled after it has been placed on the polymer and, in some embodiments, another layer of conductive organic polymer may be applied over the sample. The sample may be analyzed using any suitable mass spectrometry-based method, e.g., MIBI, as described below.

In some embodiments, the method may be done by placing a sample that comprises analytes on an optically transparent substrate (which may comprise a layer of metal, e.g., gold, or conductive organic polymer, as illustrated in FIG. 1) and applying a layer of a conductive organic polymer on top of the sample. This may be done by, e.g., spraying, spin coating or spreading a composition comprising a solvent and the polymer on the surface of the substrate and then removing the solvent by evaporation. For example, one can spray, spin coat or spread a composition comprising PEDOT, PSS, DMSO₂ and an organic solvent on the sample, and then drying it, leaving the layer of conductive organic polymer. In these embodiments, the method may comprise analyzing the sample using a mass spectrometry-based method.

Also provided is a support comprising (a) an optically transparent substrate; and (b) a layer of a conductive organic polymer (e.g., PEDOT:PSS) that is on a surface of the substrate. As noted above, the layer of (b) may comprise a cross-linking agent (e.g., a silane or a siloxane) that improves adhesion of soft tissue samples.

As noted above, the layer of conductive polymer can be added “pre-labeling” or “post-labeling”, meaning that the layer of conductive polymer can be added to the substrate before the sample is placed on the substrate (on top of the polymer) and then labeled, or after the sample is placed on the substrate. In the latter case the sample is placed on the substrate, labeled, and then covered in the polymer. In some embodiments, the sample may be sandwiched between two layers of the conductive polymer.

The substrate is not part of a solar cell, an in vivo electrode, or an organic light-emitting diode (OLED). Rather, the substrate is typically used for microscopy and, as such, is typically made of glass or a clear plastic and has the approximate size and shape of a microscope slide.

As noted above, the sample may be read by MIBI (or another mass spectrometry-based analysis method such as MALDI or potentially Cy-TOF). In these embodiments, the method may involve labeling the sample with multiple mass tags (where the term “mass tag” refers to any stable isotope of any element, including transition metals, post-transition metals, halides, noble metals or lanthanides, that is identifiable by its mass, distinguishable from other mass tags, and used to tag a biologically active material or analyte) and then scanning the sample by secondary ion mass spectrometry (SIMS) using a positively or negatively charged ion beam to generate a data set that comprises spatially-addressed measurements of the identity and abundance of the mass tags across the sample. Because ionization removes a layer from the top of the sample and the ion beam can raster through the sample several times, the spatially-addressed measurements can be used to reconstruct a two-dimensional or three-dimensional image of the sample. The general principles of MIBI, including methods by which samples may be made, methods for ionizing the tags, and methods for analyzing the data, as well as hardware that can be employed in MIBI, including but not limited to, mass spectrometers and computer control systems are known and are reviewed in a variety of publications including, but not limited to Angelo et al. Nature Medicine 2014 20:436, Rost et al. Lab. Invest. 2017 97:992-1003, U.S. Pat. Nos. 9,766,224, 9,312,111 and US2015/0080233, among many others, which patents and publications are incorporated by reference herein for disclosure of those methods and hardware.

In these embodiments, the term “labeling” refers to attaching a detectable moiety to an analyte such that the presence and/or abundance of the analyte can be determined by evaluating the presence and/or abundance of the label. In these embodiments, the mass tag is typically conjugated to an antibody, but it could be conjugated to another type of binding agent such as an aptamer or oligonucleotide. The term “labeling” includes labeling using a histological stain (in which case the mass tag may be part of or conjugated to the stain) as well as labeling using a capture agent, e.g., an antibody or an oligonucleotide probe, that has been conjugated to a mass tag. A sample can also be labeled by feeding the sample with a mass-tagged compound (e.g., IdU or BrdU) that is metabolized and incorporated into the sample prior to fixation.

A mass tag has an atomic mass that is distinguishable from the atomic masses present in the analytical sample and in the particle of interest. The term “monoisotopic” means that a tag contains a single type of metal isotope (although any one tag may contain multiple metal atoms of the same type). Lanthanides are elements having atomic numbers 58 to 71 and can be readily used herein because they can be chelated by diethylene triamine penta-acetic acid (DTPA) or 1,4,7,10-tetraazacyclododecane-1,4,7,10-tetraacetic acid (DOTA). Specifically, the term “mass tag” refers to a molecule that is tagged with either a single kind of stable isotope that is identifiable by its unique mass or mass profile or a combination of the same, where the combination of stable isotopes provides an identifier. Combinations of stable isotopes permit channel compression and/or barcoding. Examples of elements that are identifiable by their mass include noble metals and lanthanide, although other elements may be employed. An element may exist as one or more isotopes, and this term also includes isotopes of positively and negatively metals. The terms “mass tagged” and “elementally tagged” may be used interchangeably herein.

The mass tag used in the method may be any stable isotope that is not commonly found in the sample under analysis. These may include, but are not limited to, the high molecular weight members of the transition metals (e.g., Rh, Ir, Cd, Au), post-transition metals (e.g., Al, Ga, In, Tl), metalloids (e.g., Te, Bi), alkaline metals, halogens, and actinides, although others may be used in some circumstances. A mass tag may have an atomic number in the range of 21 to 238. In certain embodiments, a lanthanide may be used. The lanthanide series of the periodic table comprises 15 elements, 14 of which have stable isotopes (La, Ce, Pr, Nd, Sm, Eu, Gd, Tb, Dy, Ho, Er, Tm, Yb, Lu). Lanthanides can be readily used because of their rarity in the biosphere. There are more than 100 stable isotopes of elements having an atomic number between 1 and 238 that are not commonly found in biological systems. In some embodiments, tagging isotopes may comprise non-lanthanide elements that can form stable metal chelator tags for the applications described herein. When using a SIMS-based measurement method, in contrast to some inductively coupled plasma mass spectrometry (ICP-MS)-based methods, the elemental reporter could also comprise lower MW transition elements not common in biological systems (e.g. Al, W, and Hg). Elements suitable for use in this method in certain embodiments include, but are not limited to, lanthanides and noble metals such as gold, silver or platinum. In certain cases, an elemental tag may have an atomic number of 21-92. In particular embodiments, the elemental tag may contain a transition metal, i.e., an element having the following atomic numbers, 21-29, 39-47, 57-79, and 89. Transition elements include the lanthanides and noble metals. See, e.g., Cotton and Wilkinson, 1972, pages 528-530. The elemental tags employed herein are not commonly present in typical biological samples, e.g., cells, unless they are provided exogenously. In typical embodiments, the mass tags may be attached to antibodies (via a chelator, such as DOTA and DTPA) and the sample will be labeled with the antibodies in a multiplexed way before analysis where the term “multiplexing” refers to using more than one label for the simultaneous or sequential detection and measurement of biologically active material.

In embodiments in which the sample is read by multiplexed ion beam imaging (MIBI), each reading step may produce an image of the sample showing the pattern of binding of multiple binding agents. In particular embodiments, in any one pixel of the image, the intensity of the color of the pixel correlates with the magnitude of the signals obtained for a mass tag obtained in the original scanning. In these embodiments, the resulting false color image may show color-code cells in which the intensity of the color in any single pixel of a cell correlates with the amount of specific binding reagent that is associated with the corresponding area in the sample.

In addition to the labeling methods described above, the sample may be stained using a cytological stain, either before or after performing the method described above. The stain may enhance contrast or imaging of intracellular or extracellular structures. In some embodiments, the sample may be stained with haematoxylin and eosin (H&E).

In some embodiments, a biological sample may be isolated from an individual, e.g., from a soft tissue or from a bodily fluid, or from a cell culture that is grown in vitro. A biological sample may be made from a soft tissue such as brain, adrenal gland, skin, lung, spleen, kidney, liver, spleen, lymph node, bone marrow, bladder stomach, small intestine, large intestine or muscle, etc., or it may contain single cells. Biological samples also include cells grown in culture in vitro. A cell may be a cell of a tissue biopsy, scrape or lavage or cells. In particular embodiments, the cell may of a cell in a formalin fixed paraffin embedded (FFPE) sample. In particular cases, the method may be used to analyze cancer cells in an FFPE sample. The MIBI method described above finds particular utility in examining tissue sections using panels of antibodies. Cells any organism, e.g., from bacteria, yeast, plants and animals, such as fish, birds, reptiles, amphibians and mammals may be used in the subject methods. In certain embodiments, mammalian cells, i.e., cells from mice, rabbits, primates, or humans, or cultured derivatives thereof, may be used.

In order to further illustrate the present invention, the following specific examples are given with the understanding that they are being offered to illustrate the present invention and should not be construed in any way as limiting its scope.

### EXAMPLES

### Materials

PEDOT:PSS (poly(3,4-ethylenedioxythiophene): (poly(styrenesulfonate) (#655201), polyaniline (emeraldine salt) (#428329-5G), Dimethyl sulfone (#8032840005), acetone (#179124-1L), methanol (#322415-1L), ethanol (#1009834000), xylene, HCl (#1090571000), (3-aminopropyl) triethoxysilane (#440140-500ML), (3-aminopropyl) trimethoxysilane (#281778-100ML), (3-glycidyloxypropyl) trimethoxysilane (#440167-100ML), 1,2 Bis (3-glycidyloxyproyl) tetramethyldisiloxane (#14845-100ML-F), aniline (#242284-5ML), N-[3-(trimethoxysilyl) propyl] aniline (#440809-50ML), ammonium persulfate (#A3678-25G) were purchased from Sigma-Aldrich, USA. Target Retrieval Solution, pH 9, (3:1), (#S2375, Agilent Dako, USA). Target Retrieval Solution, Citrate pH 6, (#S2369, Agilent Dako, USA). Thermo Scientific™ Lab Vision™ PT Module (Thermo Fisher Scientific, USA).

### Example 1

This example provides a way to coat an optically transparent substrate, in this case a glass slide, with a conductive polymer. In this example, the microscope glass slide used as inorganic substrate is functionalized with organosilane coupling agents. First, the substrate (microscope slide) is cleaned with distilled water and then acetone. The slide is immersed for 5 min aminopropyltriethoxysilane/acetone 2% (v/v) solution. This will give a layer of aminopropyl, creating a positively charged surface. The slide is then transferred in a (3-glycidyloxypropyl) trimethoxy silane/acetone 2% (v/v) solution for 20 min. The silanol condensation is the major reaction in acetone leaving an epoxy functionalized coated surface. The slide is then quickly rinse in acetone and dried with a stream of nitrogen. The slide is then baked 1h to 16 h at 70° C. The slide is kept at room temperature until use in a vacuum sealed bag with desiccant and oxygen absorber.

A high conductivity grade poly(3,4-ethylenedioxythiophene)-poly(styrenesulfonate) (PEDOT:PSS) 3-4% in H₂O (Sigma-Aldrich, #655201) is deionized for 16 h at room temperature with an anion exchange resin (AG 501-X8, BIO RAD, #1436425) and then sonicated for 30 min and filtered with a 0.45 μm PDVF filter (Millipore, #SLHV033RS). Dimethyl sulfone (Sigma-Aldrich, #8.032284) is added in the PEDOT suspension at 1 to 4% (w/v). The PEDOT/DMSO2 solution is sonicated for 30 min. The addition of DMSO₂ stabilizes the PEDOT:PSS colloid in solution and improve polymer alignment (Zhu et al. (2019) Front. Chemistry 7:783). Glycidyloxypropyl trimethoxy silane (GLYMO) is diluted in methanol at 0.01 to 0.1%. The methanol/GLYMO is then added to a volume of PEDOT/DMSO2 solution to obtain 0.2 to 0.5% of PEDOT:PSS (v/v). A homogeneous suspension is obtained by adding gradually H₂O (10% v/v) at the methanol/PEDOT interphase and finally vortex. The suspension (0.2 to 1 mL) is then sprayed over the organosilane functionalized microscope slide. The slide is then baked 16h-24 h at 70° C. The slide is kept at room temperature until use in a vacuum sealed bag with desiccant and oxygen absorber. The 1,2 Bis (3-glycidyloxyproyl) tetramethyldisiloxane can be added in supplement to increase adherence with tissue.

### Example 2

This example provides another way to coat an optically transparent substrate, in this case a glass slide, with a conductive polymer. In this example, the substrate (microscope slide) is cleaned with acetone and distilled water. The slide is treated with 10% sodium hydroxide for 1 h and rinsed with distilled water. The slide is then incubated 5 min in acetone. The slide is then treated for 1 h in a 2% (v/v) solution of N-(3-(trimethoxysilyl) propyl) aniline/acetone. The slide is then quickly rinse in acetone and dried with a stream of nitrogen. The slide is baked 1h to 16 h at 70° C. The slide is kept at room temperature until use in a vacuum sealed bag with desiccant and oxygen absorber.

A solution of aniline 1-4.5% (v/v) was mixed quickly with ammonium persulfate (100 mM final concentration) in 1 M HCl and applied directly on the aniline silane functionalized slide. The polymerization reaction was incubated for 15 min at room. The slide was then washed with acetone to remove the excess of polyaniline (emeraldine salt). The slide was then quickly rinsed in acetone and dried with a stream of nitrogen and baked for 1h to 16 h at 70° C.

### Example 3

This example provides a way to coat an optically transparent substrate, in this case a glass slide, with a conductive polymer. In this example, the excess polyaniline (PANI) suspension obtained in Example 2 was washed with 10 volumes of methanol. Dimethyl sulfone (Sigma-Aldrich, #8.032284) is added in the polyaniline suspension at 1 to 4% (w/v). The PANI/DMSO₂ suspension was sonicated for 30 min. Glycidyloxypropyl trimethoxy silane diluted in methanol at 0.01 to 0.1%. The PANI suspension (0.2 to 1 mL) was sprayed over the epoxy organosilane functionalized microscope slide. The slide is then baked 16h-24 h at 70° C. The slide is kept at room temperature until use in a vacuum sealed bag with desiccant and oxygen absorber.

### Example 4

This example provides a way add a conductive polymer coating onto a tissue section that is already on a slide. In this example, PEDOT/DMSO2/Methanol was prepared as described above. Briefly, The PEDOT/DMSO2 suspension was diluted in methanol at 0.01 to 0.1% v/v. A homogeneous suspension is obtained by adding gradually H₂O (10% v/v) at the methanol/PEDOT interphase and finally vortex. The suspension (0.2 to 1 mL) is then sprayed over the tissue sample slide. The slide was then baked for 1 h at 70° C. and kept at room temperature until use in a vacuum sealed bag with desiccant and oxygen absorber.

### Example 5

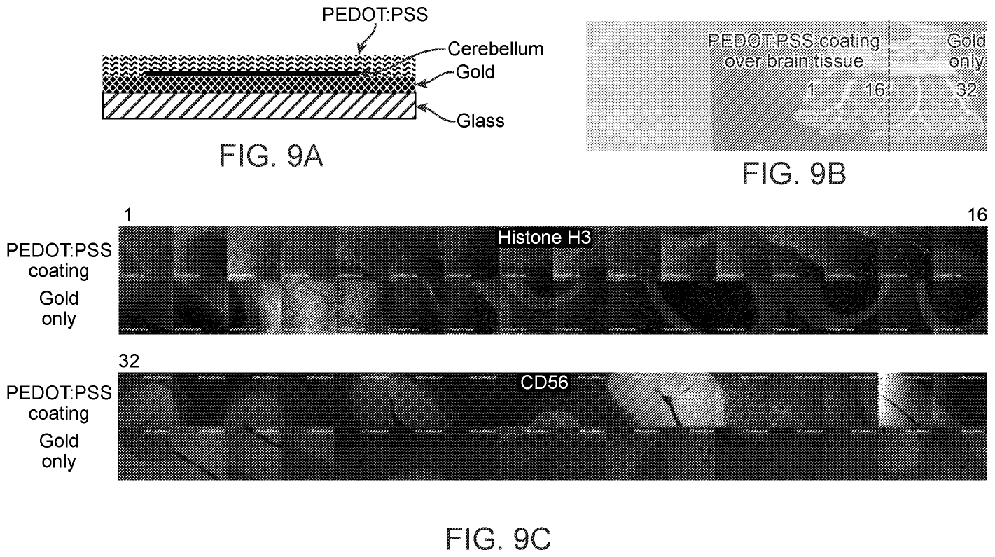

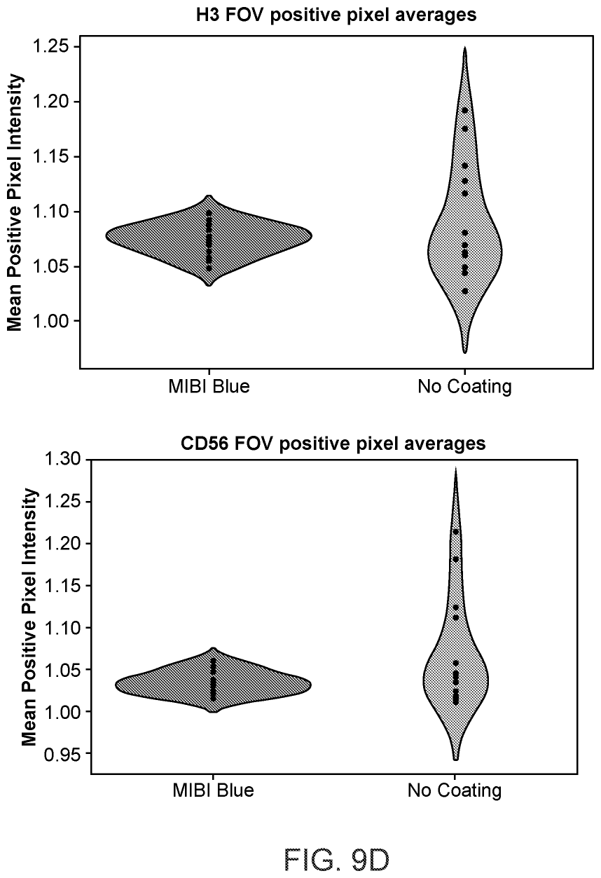

This example provides another way add a conductive polymer coating onto a tissue section that is already on a slide. In this example, conductive polyaniline (emeraldine salt), 1-4% was suspended in DMSO2/water (3% w/v) solution. The PANI/DMSO₂ suspension was then sonicated for 30 min. The PANI/DMSO2 solution was diluted in methanol at 0.2 to 0.5% v/v. The PANI/DMSO FIG. 9A2 suspension (0.2 to 1 mL) was sprayed over the tissue sample slide. The slide was then baked for 1 h at 70° C. and kept at room temperature until use in a vacuum sealed bag with desiccant and oxygen absorber.

### Example 6

Material: Polyethylenimine, branched (Sigma-Aldrich, #408719-100 mL), 1,4-butanediol diglycidyl ether, (Sigma-Avrich, #220892-50g), sodium carbonate (Sigma-Aldrich, #S2127-500g)

First, the substrate (microscope slide) is cleaned with distilled water and then acetone. The slide is immersed for 5 min aminopropyltriethoxysilane/acetone 2% (v/v) solution. This will give a layer of aminopropyl, creating a positively charged surface. The slide is then transferred in a (3-glycidyloxypropyl) trimethoxy silane/acetone 2% (v/v) solution for 20 min. The silanol condensation is the major reaction in acetone leaving an epoxide functionalized coated surface. The slide is then quickly rinse in acetone and dried with a stream of nitrogen. The slide is then baked 1 h at 70° C. The slides are incubated in a 2 to 10 mM polyethylenimine (MW 800 to 25000), (Sigma-Aldrich, #408719-100 mL) and butanediol diglycidyl ether in a sodium carbonate buffer (100 mM) at 45° C. for 16 to 24 h. The polyethylenimine amine group will react with the epoxide functionalized groups and form a cationic scaffold at the surface of the substrate which improves the wettability. The slides are then washed with water, rinse in acetone and dried with a stream of nitrogen.

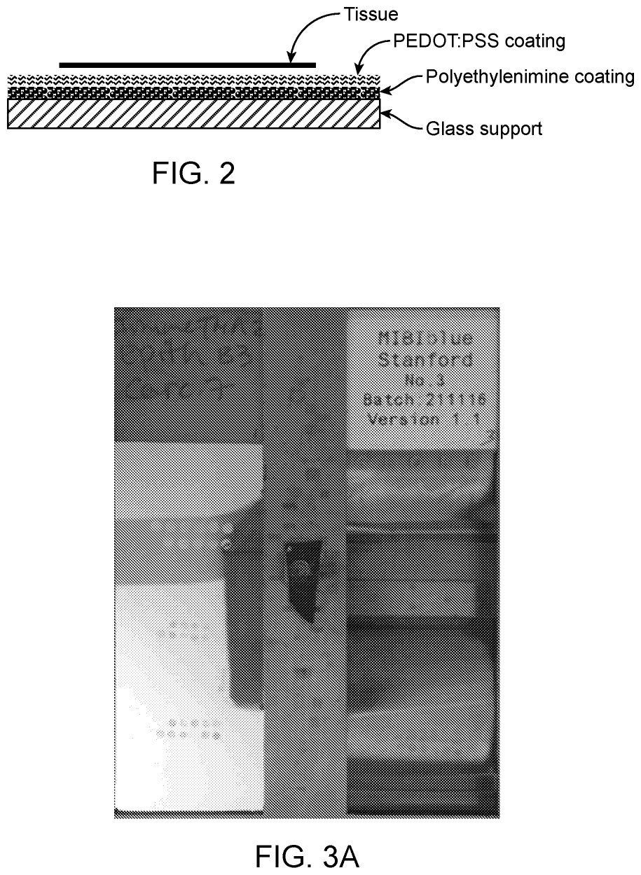

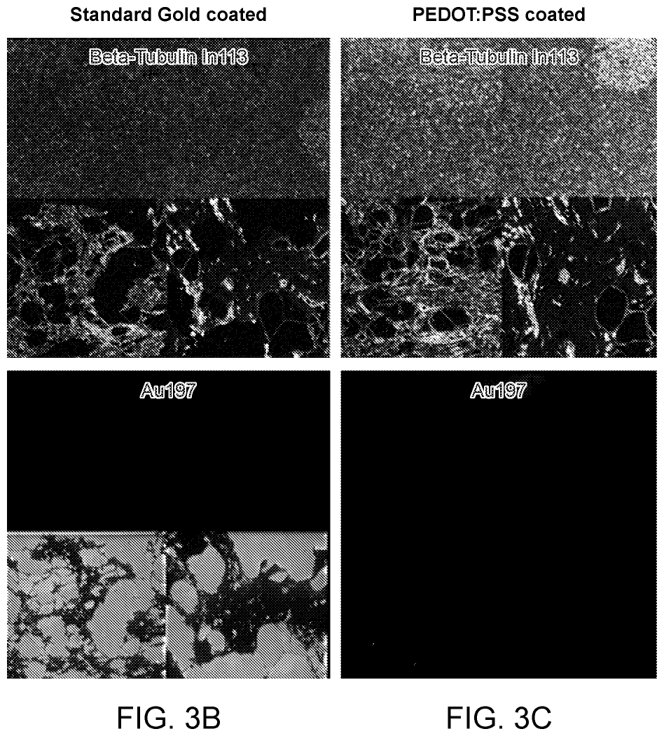

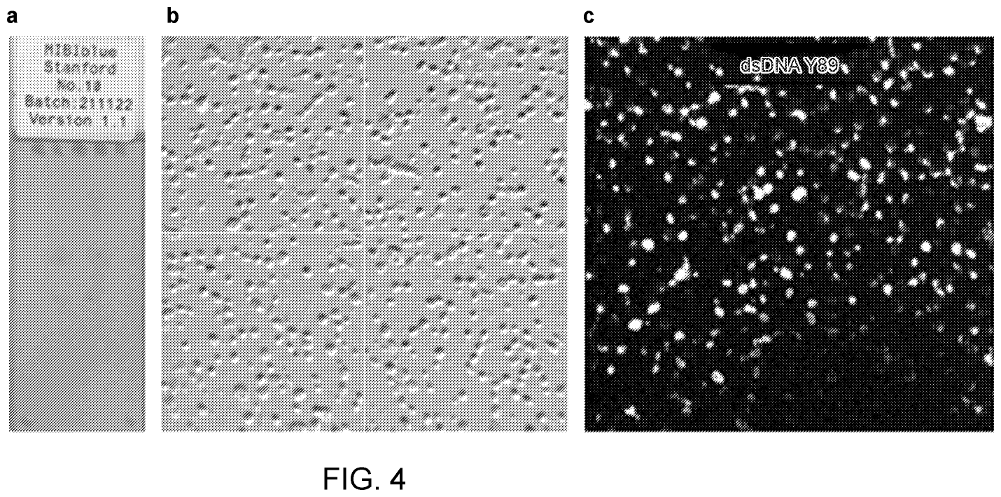

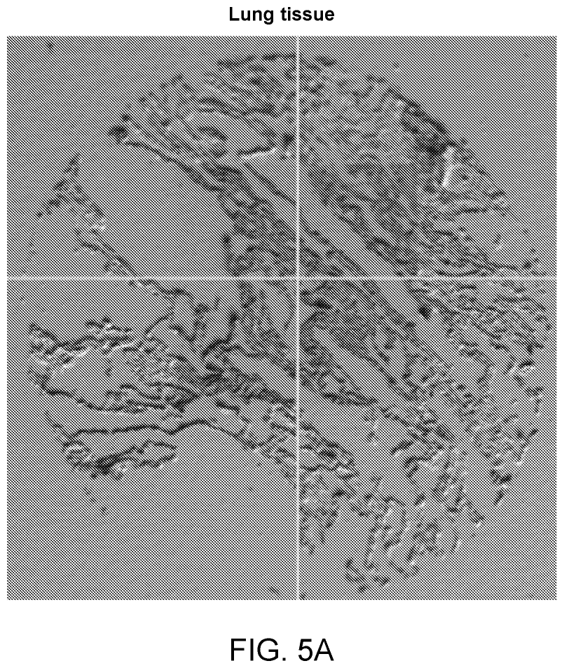

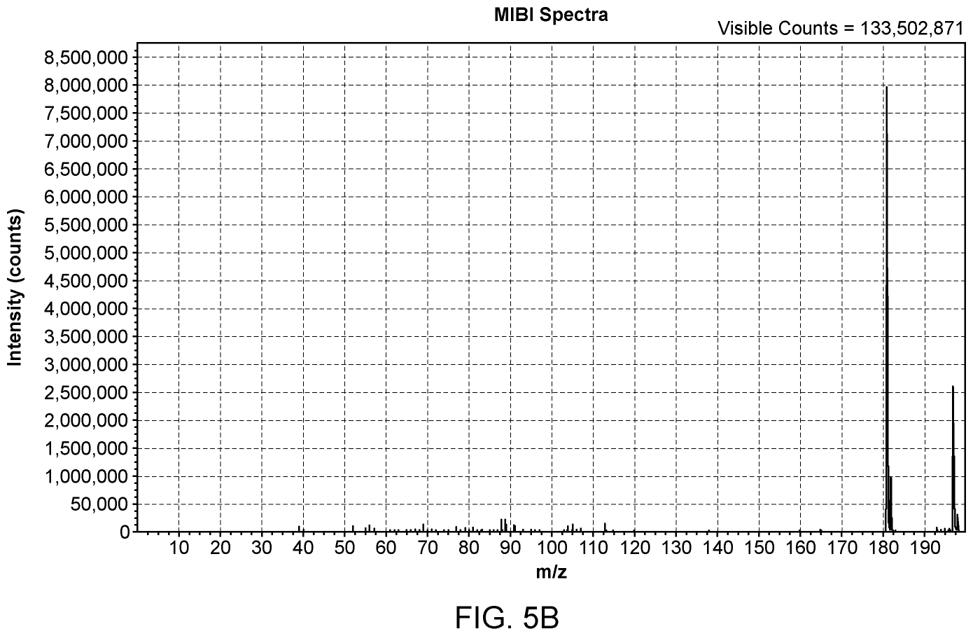

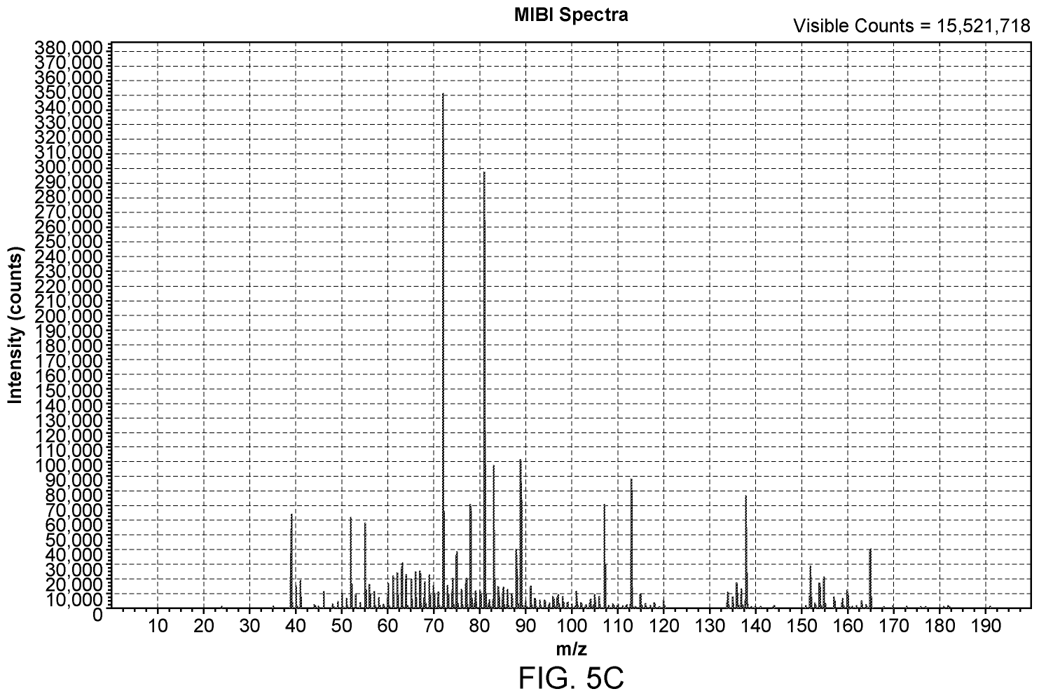

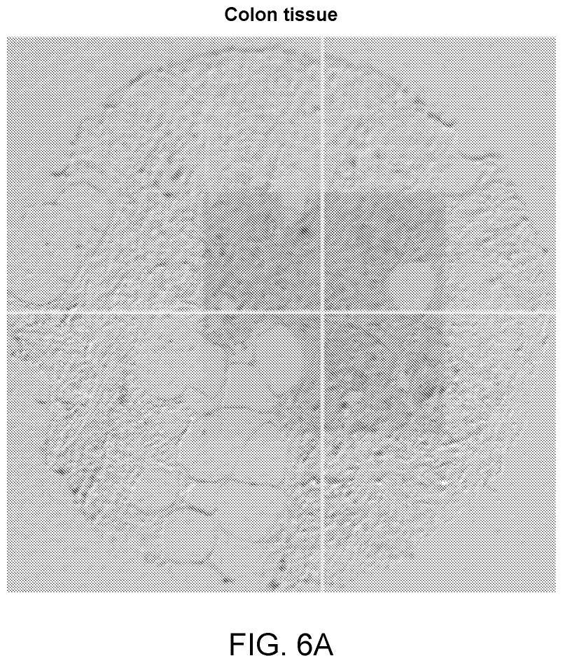

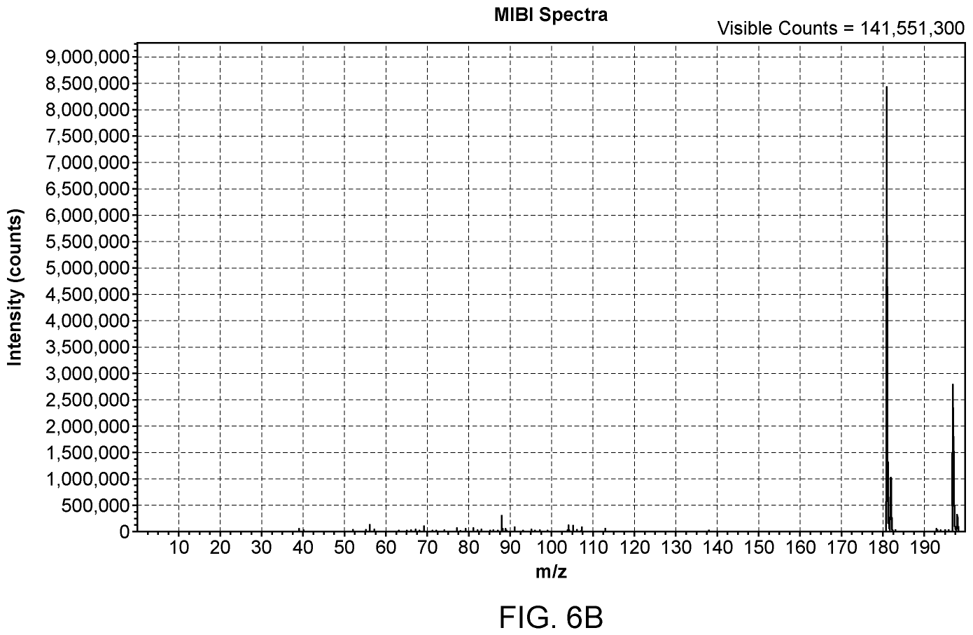

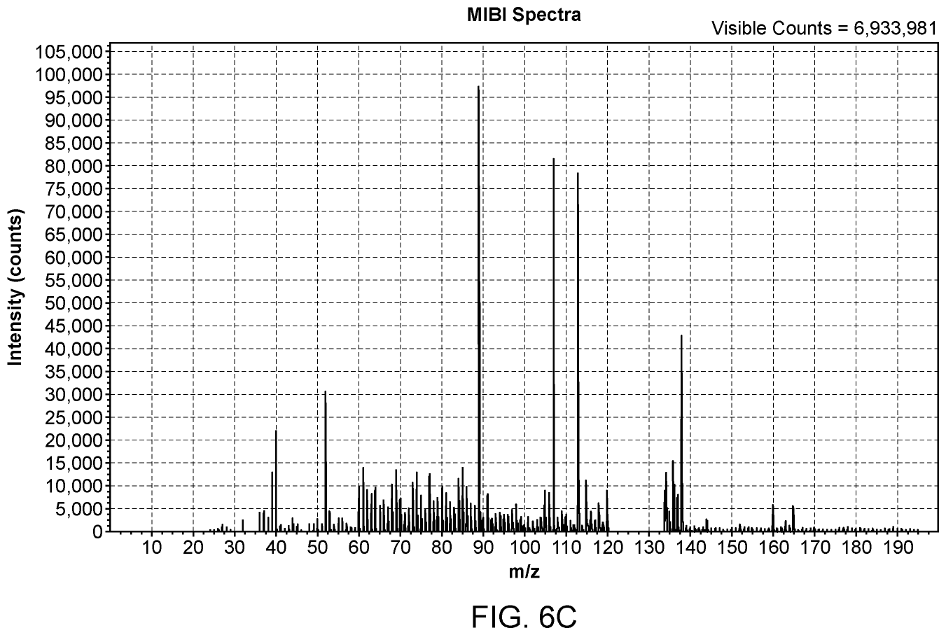

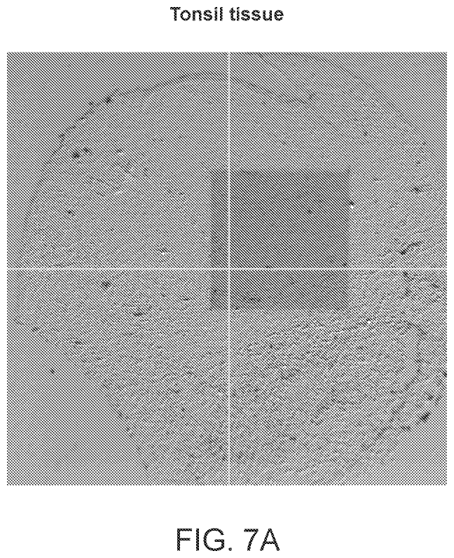

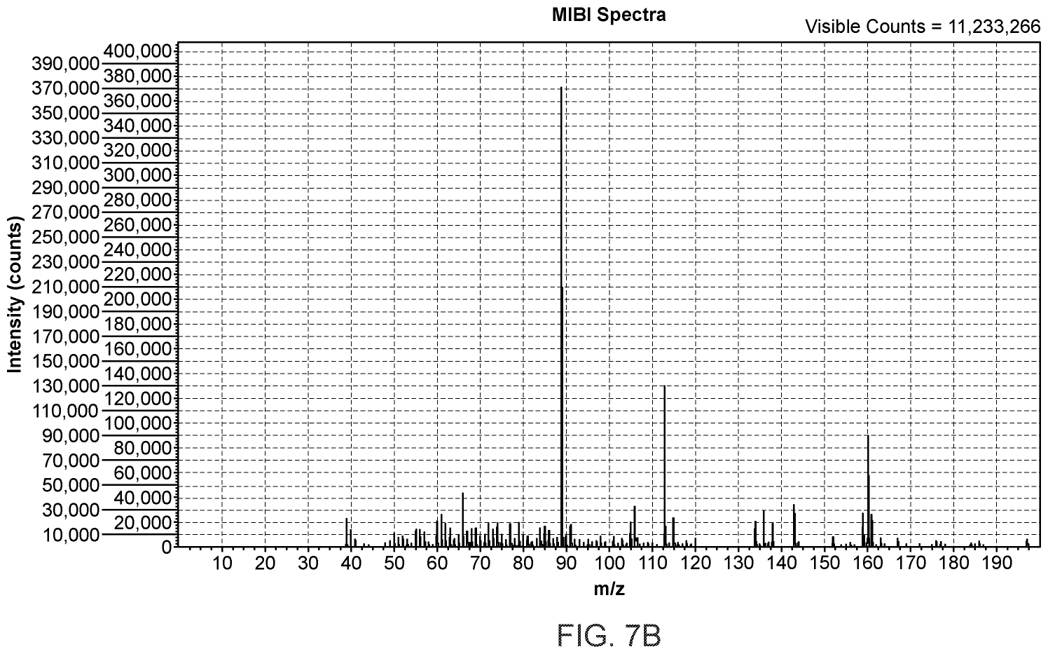

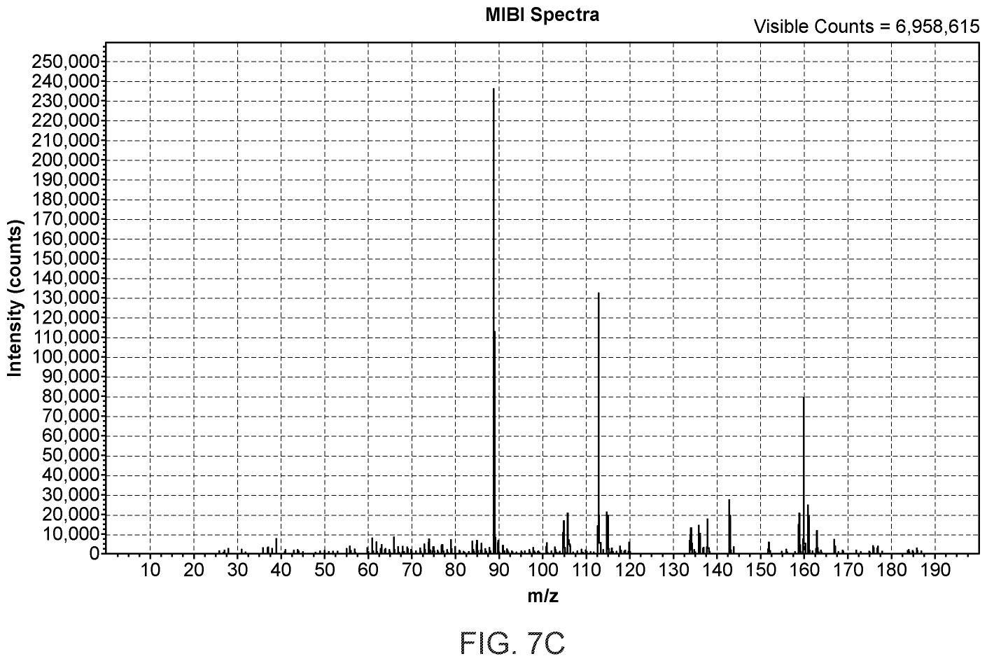

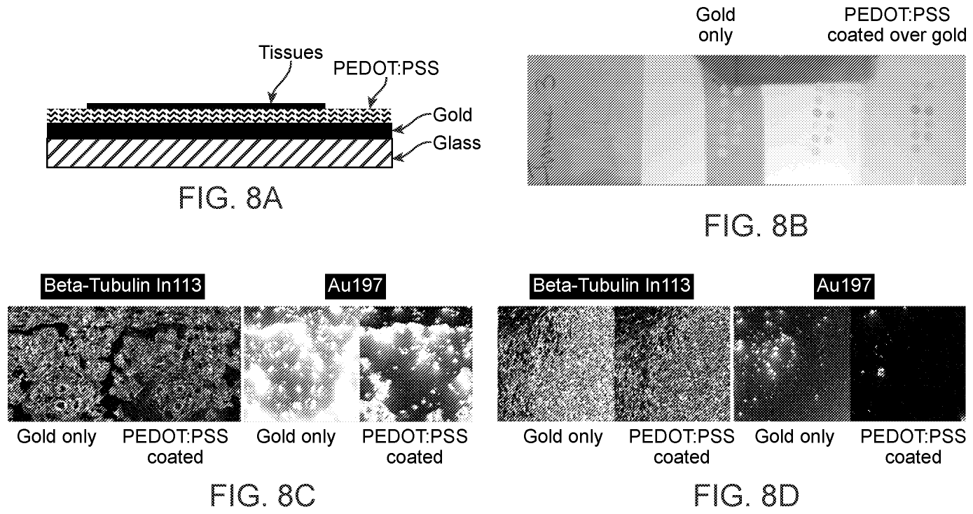

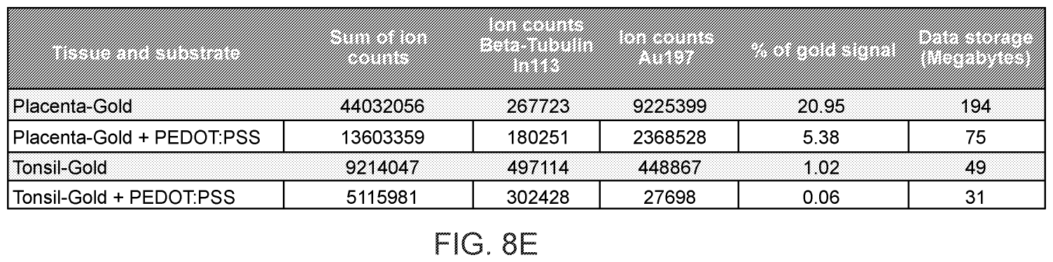

A high conductivity grade poly(3,4-ethylenedioxythiophene)-poly(styrenesulfonate) (PEDOT:PSS) 3-4% in H₂O (Sigma-Aldrich, #655201) is sonicated for 30 min and filtered with a 0.45 μm PDVF filter (Millipore, #SLHV033RS). 1,4-Butanediol diglycidyl ether, (Sigma-Aldrich, #220892-50g) is diluted in methanol at 0.01 to 0.1%. The methanol/butanediol diglycidyl ether is then added to a volume of PEDOT to obtain 0.2 to 2% of PEDOT:PSS (v/v). A homogeneous suspension is obtained by adding gradually H₂O (10% v/v) at the methanol/PEDOT interphase and finally vortex. The suspension (0.2 to 1 mL). The formulation can then be sprayed or spread over the polyethyleneimine functionalized microscope slide. The slide is then baked 16h-24 h at 70° C. The slide is kept at room temperature until use in a vacuum sealed bag with desiccant and oxygen absorber. The 1,2 Bis (3-glycidyloxyproyl) tetramethyldisiloxane can be added in supplement to increase adherence with tissue. This arrangement is shown in FIG. 2.

What is claimed is:

1. A combination comprising:
(a) an optically transparent substrate;
(b) a sample that comprises biological analytes; and
(c) a layer of a conductive organic polymer;
wherein: (i) the layer of polymer is between the sample and the substrate,
(ii) the layer of polymer coats the section on the opposite side to the substrate, or
(iii) both (i) and (ii).

2. The combination of claim 1, wherein the polymer is poly(3,4-ethylenedioxythiophene) polystyrene sulfonate (PEDOT:PSS) or polyaniline (emeraldine salt).

3. The combination of claim 1 or 2, wherein the layer has a thickness in the range of 1 nm to 500 nm.

4. The combination of any prior claim, wherein the polymer comprises a cross-linker that improves adhesion of the sample to the layer of polymer.

5. The combination of any prior claim, wherein the sample comprises cells.

6. The combination of any prior claim, wherein the sample is a tissue section, a cell monolayer or one or more single cells.

7. The combination of any prior claim, wherein the substrate is glass or plastic.

8. A method comprising:
(a) functionalizing an optically transparent substrate; and
(b) applying a layer of a conductive organic polymer to the functionalized substrate.

9. The method of claim 8, wherein the optically transparent substrate is silanized in step (a).

10. The method of claim 8 or 9, wherein the layer of (b) comprises a cross-linking agent that improves adhesion of a soft tissue sample.

11. The method of claim 10, wherein the cross-linking agent is a silane or a siloxane.

12. The method of any of claims 8-11, wherein the applying step comprises spraying, spin coating or spreading a liquid composition comprising a solvent and the polymer onto the surface of the substrate and then removing the solvent by evaporation.

13. The method of claim 11, wherein the liquid composition comprises PEDOT, PSS, DMSO₂ and an organic solvent or polyaniline (emeraldine salt), DMSO₂ and an organic solvent.

14. The method of any of claims 8-13, further comprising placing a sample that comprises biological analytes on the layer of polymer on the opposite side to the substrate.

15. The method of claim 14, further comprising analyzing the sample using a mass spectrometry-based method.

16. A method for preparing a sample comprising:
placing a sample that comprises analytes on an optically transparent substrate; and
applying a layer of a conductive organic polymer on top of the sample.

17. The method of claim 16, wherein the applying comprises spraying, spin coating or spreading a composition comprising a solvent and the polymer on the surface of the substrate and then removing the solvent by evaporation.

18. The method of claim 16 or 17, wherein the composition comprises PEDOT, PSS, DMSO₂ and an organic solvent or polyaniline (emeraldine salt), DMSO₂ and an organic solvent.

19. The method of claim 18, further comprising analyzing the sample using a mass spectrometry-based method.

20. A support comprising:
(a) an optically transparent substrate; and
(b) a layer of a conductive organic polymer that is on a surface of the substrate.

21. The support of claim 20, wherein the layer of (b) comprises a cross-linking agent (e.g., a silane or a siloxane) that improves adhesion of a soft tissue sample.
